(19) United States
(12) Patent Application Publication
(10) Pub. No.: US 2017/0293866 A1
(43) Pub. Date: Oct. 12, 2017

(54) Intelligent Seat Management

(71) Applicant: International Business Machines Corporation, Armonk, NY (US)

(72) Inventors: Michael Bender, Rye Brook, NY (US); Michael P. Shute, Niantic, CT (US); Siddhartha Sood, Ghaziabad (IN)

(21) Appl. No.: 15/096,757

(22) Filed: Apr. 12, 2016

(51) Int. Cl. G06Q 10/02; G06F 3/0484; H04L 29/08; G06F 17/30

(52) U.S. Cl. CPC G06Q 10/02; G06F 17/3053; G06F 3/04842; H04L 67/306

(57) ABSTRACT

Providing seating recommendations is provided. Seating recommendations for a current day in an open seating environment are generated based on analysis of previous seat selection information, calendar information, and social network information corresponding to a user and current seat assignments to other users in the open seating environment. A weight for each of the seating recommendations for the current day in the open seating environment is generated based on the analysis of the previous selection information, the calendar information, and the social network information corresponding to the user. The seating recommendations are ordered by weight. A pre-defined top number of the seating recommendations ordered by weight are provided to the user.

### BACKGROUND

### 1. Field

The disclosure relates generally to seat management and more specifically to automatically providing intelligent seating recommendations for a current day within an open seating environment to a user based on previous seat selection information, calendar information, and social network information corresponding to the user.

### 2. Description of the Related Art

One type of work environment is an open seating work environment. The open seating work environment makes use of large, open spaces that minimize the use of small, enclosed rooms, such as private offices. This open seating work environment is designed for team building and camaraderie. For example, employees may work more effectively when their work spaces are located in close spatial proximity with respect to other teammates within their respective work groups. However, in the open seating environment employees are not assigned a fixed seat or workstation, but each employee must select a seat within the open seating work environment on a daily basis, such as on a first come, first serve basis. In such a situation, there is no assurance that employees in a same work group will be seated in close proximity to one another from day to day.

### SUMMARY

According to one illustrative embodiment, a computer-implemented method for providing seating recommendations is provided. A computer generates the seating recommendations for a current day in an open seating environment based on analysis of previous seat selection information, calendar information, and social network information corresponding to a user and current seat assignments to other users in the open seating environment. The computer generates a weight for each of the seating recommendations for the current day in the open seating environment based on the analysis of the previous selection information, the calendar information, and the social network information corresponding to the user. The computer orders the seating recommendations by weight. The computer provides a pre-defined top number of the seating recommendations ordered by weight to the user. According to other illustrative embodiments, a computer system and computer program product for providing seating recommendations are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a seat management system in accordance with an illustrative embodiment; and

FIG. 4 is a flowchart illustrating a process for providing seating recommendations in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

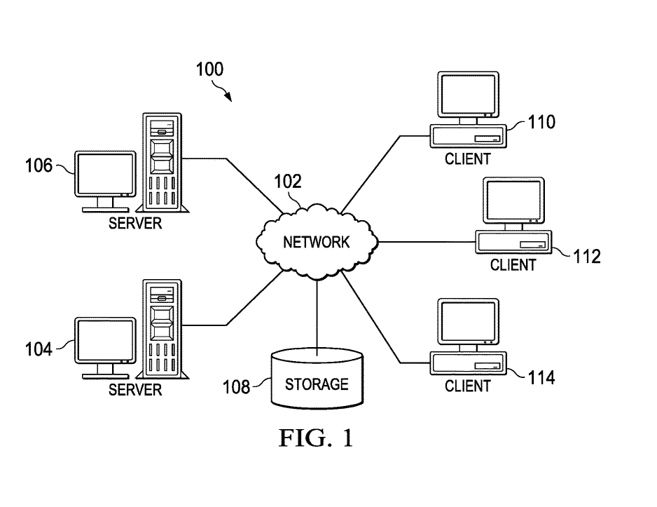

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of services to users of registered clients. The set of services may include, for example, seat management services for a set of one or more open seating environments. For example, server 104 or server 106 may provide a set of one or more intelligent seating recommendations for a current day to a user requesting a seat recommendation within an open seating environment. In addition, server 104 and server 106 may monitor the set of one or more open seating environments using a set of sensors, such as imaging devices, sound sensing devices, motion sensing devices, pressure sensing devices, thermal sensing devices, or any combination thereof.

Client 110, client 112, and client 114 also connect to network 102. Clients 110, 112, and 114 are registered clients of server 104 and server 106. Server 104 and server 106 may provide information, such as boot files, operating system images, and software applications to clients 110, 112, and 114.

In this example, clients 110, 112, and 114 are illustrated as desktop computers, which may have wire or wireless communication links to network 102. However, it should be noted that clients 110, 112, and 114 are intended as examples only. In other words, clients 110, 112, and 114 also may include other devices, such as, for example, laptop computers, handheld computers, smart phones, smart watches, personal digital assistants, gaming devices, kiosks, or any combination thereof. Users of clients 110, 112, and 114 may utilize clients 110, 112, and 114 to access the seat management services provided by server 104 or server 106 and receive seating recommendations in open seating environments.

Storage 108 is a network storage device capable of storing any type of data in a structured format or an unstructured format. In addition, storage 108 may represent a set of one or more network storage devices. Storage 108 may store, for example, names and identification numbers for a plurality of different users of the seat management services, user profile information, user calendar information, user social network information, open seating environment information, previous seat selections made by users on previous days, current day seating recommendations with weighting information, and current day seat selections made by users. Further, storage 108 may store other data, such as authentication or credential data that may include user names, passwords, and biometric data associated with the plurality of different users and system administrators, for example.

In addition, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example, and not as an architectural limitation for the different illustrative embodiments.

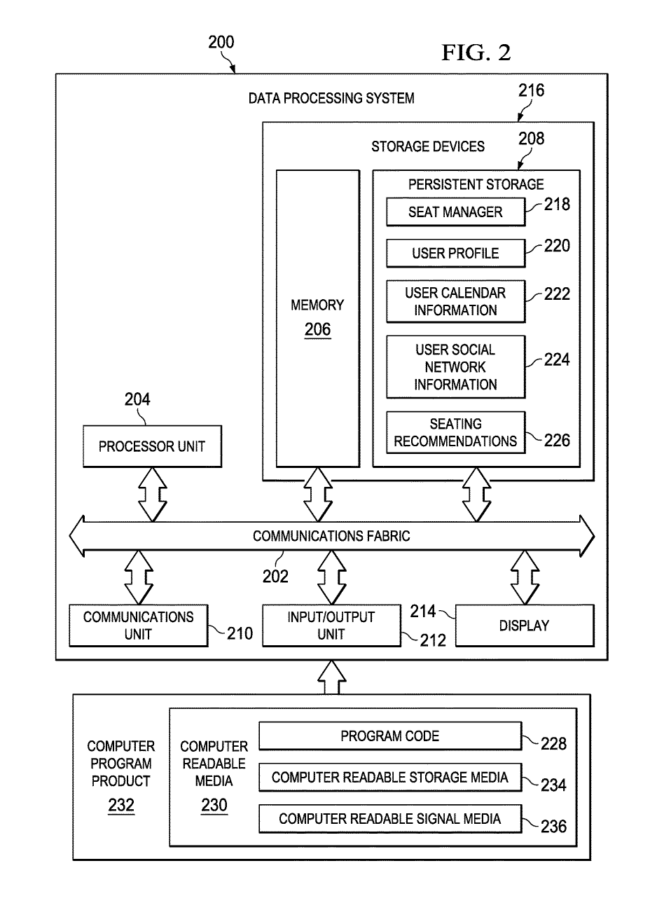

With reference now to FIG. 2, a diagram of a data processing system is depicted in accordance with an illustrative embodiment. Data processing system 200 is an example of a computer, such as server 104 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores seat manager 218. Seat manager 218 generates and provides a set of one or more seating recommendations for a current day within an open seating work environment of an enterprise to a user of a client device based on, for example, previous seat selection information, calendar information, and social network information corresponding to the user. The user of the client device may be, for example, a full-time or part-time employee of the enterprise, a customer of the enterprise, a contract employee employed by the enterprise, an employee of an affiliate of the enterprise, a consultant hired by the enterprise, and the like. It should be noted that even though seat manager 218 is illustrated as residing in persistent storage 208, in an alternative illustrative embodiment seat manager 218 may be a separate component of data processing system 200. For example, seat manager 218 may be a hardware component coupled to communication fabric 202 or a combination of hardware and software components.

Also in this example, persistent storage 208 stores user profile 220, user calendar information 222, user social network information 224, and seating recommendations 226. User profile 220 stores information corresponding to a particular user. For example, user profile 220 may include information such as name, identification number, demographic information, work-related information, seating preferences, current skills, areas of expertise, languages spoken, and the like, corresponding to the particular user. The work-related information may include, for example, job title, role, duties, assigned projects, corresponding work groups, and teammates or members of each corresponding work group. The seating preferences may be, for example, previous seat selections made by the user on previous days within the open seating work environment. For example, seat manager 218 may automatically record and store the previous seat selections in user profile 220. Also, the user may input seating preferences, such as lighting preferences, ventilation preferences, noise level preferences, workspace size preferences, equipment preferences, hardware preferences, software preferences, and the like, in user profile 220. It should be noted that user profile 220 represents a plurality of different user profiles corresponding to a plurality of different users.

User calendar information 222 includes calendar entries and schedules for a current day when the user is requesting a seating recommendation for that day within the open seating environment from seat manager 218. Seat manager 218 automatically retrieves user calendar information 222 via a network, such as network 102 in FIG. 1, from a set of one or more electronic calendars stored on client devices corresponding to the user. User social network information 224 includes information corresponding to the user that seat manager 218 retrieves, via the network, from social media websites, enterprise networks, professional networks, and the like. User social network information 224 may include, for example, co-workers, friends, followers, connections, communities, language preferences, and the like.

Seat manager 218 utilizes data in user profile 220, user calendar information 222, and user social network information 224 to generate seating recommendations 226. Seating recommendations 226 are a set of one or more recommendations that seat manager 218 provides to the user to meet the user's seating preferences based on user profile 220, user calendar information 222, and user social network information 224. In addition, seat manager 218 may generate and provide a weighting for each seating recommendation in seating recommendations 226. The weighting may be, for example, a plain text message describing how a particular seating recommendation meets the user's seating preferences. Alternatively, the weighting may be a numerical score that indicates a level of how well a particular seating recommendation meets the user's seating preferences. Further, seat manager 218 may provide the seating recommendations in seating recommendations 226 in a ranked list of seating recommendations from a highest weighted seating recommendation to a lowest weighted seating recommendation meeting the user's seating preferences.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 228 is located in a functional form on computer readable media 230 that is selectively removable and may be loaded onto or transferred to data processing system 200 for running by processor unit 204. Program code 228 and computer readable media 230 form computer program product 232. In one example, computer readable media 230 may be computer readable storage media 234 or computer readable signal media 236. Computer readable storage media 234 may include, for example, an optical or magnetic disc that is inserted or placed into a drive or other device that is part of persistent storage 208 for transfer onto a storage device, such as a hard drive, that is part of persistent storage 208. Computer readable storage media 234 also may take the form of a persistent storage, such as a hard drive, a thumb drive, or a flash memory that is connected to data processing system 200. In some instances, computer readable storage media 234 may not be removable from data processing system 200.

Alternatively, program code 228 may be transferred to data processing system 200 using computer readable signal media 236. Computer readable signal media 236 may be, for example, a propagated data signal containing program code 228. For example, computer readable signal media 236 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 228 may be downloaded over a network to persistent storage 208 from another device or data processing system through computer readable signal media 236 for use within data processing system 200. For instance, program code stored in a computer readable storage media in a data processing system may be downloaded over a network from the data processing system to data processing system 200. The data processing system providing program code 228 may be a server computer, a client computer, or some other device capable of storing and transmitting program code 228.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 234 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In the course of developing illustrative embodiments, it was discovered that in many work environments employees do not have an assigned seat on a daily basis. When these employees come in to work, the employees select an available seat or desk for the day. In a perfect world, an employee would select a seat near the people they work with, people they are scheduled to meet with, people they are friendly with, and people they speak the same language as. An employee also may prefer not to have to sit next to someone that is going to be on large number of conference calls when the employee is trying to work with other co-workers in the same area. Illustrative embodiments optimize seating arrangements when the number of needed seats is not fixed because the number of employees needing seats may change each day.

Illustrative embodiments utilize several different types of information sources in order to manage seating of employees on a daily basis in an open seating work environment. Illustrative embodiments utilize several factors in order to determine where an employee would be most effectively seated for the current day. For example, illustrative embodiments review an employee's electronic calendar to determine which co-workers the employee is meeting with today. In addition, illustrative embodiments use the calendar information to determine which other employees have a large number of meetings this day. Further, illustrative embodiments use internal and external social networks of the employee to determine which co-workers the employee is friendly with. Similarly, illustrative embodiments also use the internal and external social networks to determine which co-workers the employee is unfriendly with. An example of an internal social network may be a network of the enterprise employing the employee. An example of an external social network may be a social media website that the employee posts information on.

Furthermore, illustrative embodiments retrieve other information, such as skills and interests of the employee, from the internal and external social networks. Moreover, illustrative embodiments utilize organizational charts and data of the enterprise to determine work groups and corresponding teammates of the employee. Illustrative embodiments also utilize employee data to determine language preferences of the employee. In addition, illustrative embodiments utilize prior seat selections made by the employee in the open seating environment to prioritize future seating recommendations provided to the employee. Illustrative embodiments may weight these factors, some of which are positive factors while others are negative factors, and provide the employee with a recommended seat location for the day. It should be noted that illustrative embodiments also may be applied to other seating environments, such as, for example, business conferences, where illustrative embodiments may recommend seat selection and/or room selection to place people in an optimal fashion.

Several example use cases are provided below to further an understanding of illustrative embodiments. Example use case 1: an employee, Bill, has five meetings listed on his electronic calendar for today, four of which are with work group teammate, Bob. Illustrative embodiments attempt to seat Bob and Bill together in the open seating work environment as these teammates will meet frequently today. Example use case 2: another employee, Sam, does not have any meetings today on his electronic calendar. Open seats are available near Bob and Bill's work area, but illustrative embodiments attempt to seat Sam away from Bob and Bill in the open seating work environment so that Sam may work in a quieter location. Example use case 3: employee, Stan, frequently exchanges friendly communications with Sam on social media websites. Also, Stan is not as cordial to Bob on these social media websites. As a result, illustrative embodiments attempt to seat Stan closer to Sam, while attempting to seat Stan farther away from Bob in the open seating work environment.

Example use case 4: employee, Beth, includes in her profile on a professional networking website that she is an object-oriented software developer. This is a skill that Sam and Stan share as well. Consequently, illustrative embodiments apply a weight towards seating Beth closer to Stan and Sam in the open seating work environment. Example use case 5: employee, Brad, is a work group teammate of Bob and Bill. Thus, illustrative embodiments apply a weight towards seating Brad closer to Bob and Bill in the open seating work environment. Example use case 6: employee, Sarah, includes in an employee profile that her primary language is Spanish. Seats are available in a work area where English is primarily spoken and seats are available in another work area where Spanish is primarily spoken in the open seating work environment. Illustrative embodiments apply more weight towards seating Sarah in the Spanish speaking work area and apply less weight towards seating Sarah in the English speaking work area. Finally, use case 7: employee, Frank, frequently comes in to the office and always selects a seat by a window in the open seating work environment. Illustrative embodiments learn over time that Frank prefers sitting by a window and, therefore, illustrative embodiments will recommend a seat in the open seating work environment that meets Frank's seating preference (i.e., a seat by a window).

Thus, illustrative embodiments may reduce time for an employee to select a seat in an open seating work environment. In addition, illustrative embodiments may increase employee productivity by optimally seating employees within the open seating work environment.

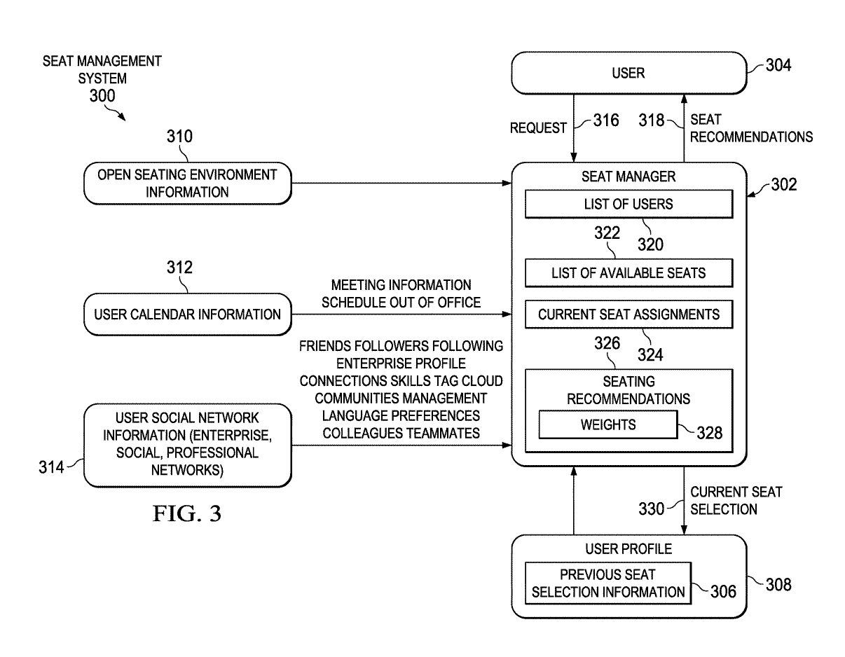

With reference now to FIG. 3, a diagram illustrating an example a seat management system is depicted in accordance with an illustrative embodiment. Seat management system 300 may be implemented in a network of data processing systems, such as, for example, network data processing system 100 in FIG. 1.

Seat management system 300 includes seat manager 302. Seat manager 302 may be, for example, seat manager 218 in FIG. 2. Seat manager 302 provides seating recommendations for a current day within an open seating environment to user 304 based on previous seat selection information 306 stored in user profile 308, open seating environment information 310, user calendar information 312, and user social network information 314. It should be noted that user 304 represents a plurality of different users that access the services provided by seat management system 300.

Seat manager 302 collects, aggregates, and processes the data retrieved from these different data sources to provide user 304 with a set of one or more seating recommendations for the current day within the open seating environment. Previous seat selection information 306 includes past seat selections made by user 304 in the open seating environment during previous work days. User profile 308 may be, for example, user profile 220 in FIG. 2. Seat manager 302 stores information related user 304 in user profile 308.

Open seating environment information 310 includes information, such as, for example, location, size of space, total number of seats, types of seats, types of lighting, ventilation, types of available equipment, and the like, which is related to the open seating environment. User calendar information 312 may be, for example, user calendar information 222 in FIG. 2. User calendar information 312 includes current day calendar entries and schedules, such as, for example, co-worker meetings, teleconference meetings, and the like, for user 304. Seat manager 302 retrieves user calendar information 312 from a set of one or more electronic calendars located on one or more client devices connected to a network, such as client 110 connected to network 102 in FIG. 1, corresponding to user 304.

User social network information 314 may be, for example, user social network information 224 in FIG. 2. Seat manager 302 retrieves user social network information 314 from a set of one or more social media websites, professional networking websites, enterprise websites, and the like, via the network. Seat manager 302 may retrieve information, such as, for example, friends and colleagues of user 304, people who are following user 304, people whom user 304 follows, an enterprise profile of user 304, skills information corresponding to user 304, communities or interest groups that user 304 is a member of, management chain corresponding to user 304, language preference of user 304, projects assigned to user 304, clients user 304 actively supports, and the like.

In addition, seat manager 302 may generate a tag cloud using the information retrieved from the different social networks of user 304. Further, seat manager 302 may classify the information retrieved from the different social networks of user 304 into dynamic information that may change every day or multiple times a day, such as calendar entries, and non-dynamic information that may not change very often, such as co-workers, friends, followers, skills, language preference, communities, and the like. Based on such a classification of the information, seat manager 302 may follow a strategy, such as, for example, background retrieval, aggregation, and processing of non-dynamic information on demand and active processing of dynamic information on a daily basis.

User 304 accesses seat management system 300 by sending request 316 to seat manager 302 requesting seat recommendations 318 within the open seating environment. First, seat manager 302 locates user 304 within list of users 320 to confirm that seat manager 302 can reserve a seat in the open seating environment to user 304. Second, seat manager 302 checks list of available seats 322 and current seat assignments 324 in the open seating environment to determine an optimal seating location for user 304. Further, seat manager 302 analyzes previous seat selection information 306 in user profile 308, user calendar information 312, and user social network information 314 corresponding to user 304 to determine the optimal seating location for user 304. Third, seat manager 302 generates seating recommendations 326, along with weights 328 for each seating recommendation in seating recommendations 326. Seating recommendations 326 may be, for example, seating recommendations 226 in FIG. 2.

Seat manager 302 transmits seating recommendations 326 with weights 328 to user 304 as seat recommendations 318 via the network. It should be noted that seat manager 302 may send only a pre-defined top number of seating recommendations 326 to user 304. Also, weights 328 may be, for example, a combination of two or more weighting factors such as work group, teammates, skills, friends, number of teleconference meetings, number of face-to-face meetings, past seat selections, and the like.

Upon receipt of seat recommendations 318, user 304 may then either select the top ranked recommended seat based on seat manager 302's recommendation or select a lower ranked seat within the open seating environment. User 304 transmits the current seat selection to seat manager 302. Seat manager 302 saves current seat selection 330 in user profile 308 and updates current seat assignments 324 to reflect the current seat selection made by user 304. In addition, seat manager 302 reserves the seat within the open seating environment corresponding to current seat selection 330 made by user 304 for the current day.

It should be noted that if user 304 selected a lower ranked recommended seat having a weighting factor of “skill” as compared to the top ranked recommended seat, which had a weighting factor of “work group”, then seat manager 302 may in future start ranking skill-based recommendations higher than work group-based recommendations for user 304. Seat manager 302 may modify the weighting of any factor for any particular user over time based on previous seat selections made by a particular user. Seat manager 302 may display recommended and available seats to the current user selecting a seat and accounting for other users that are still coming in.

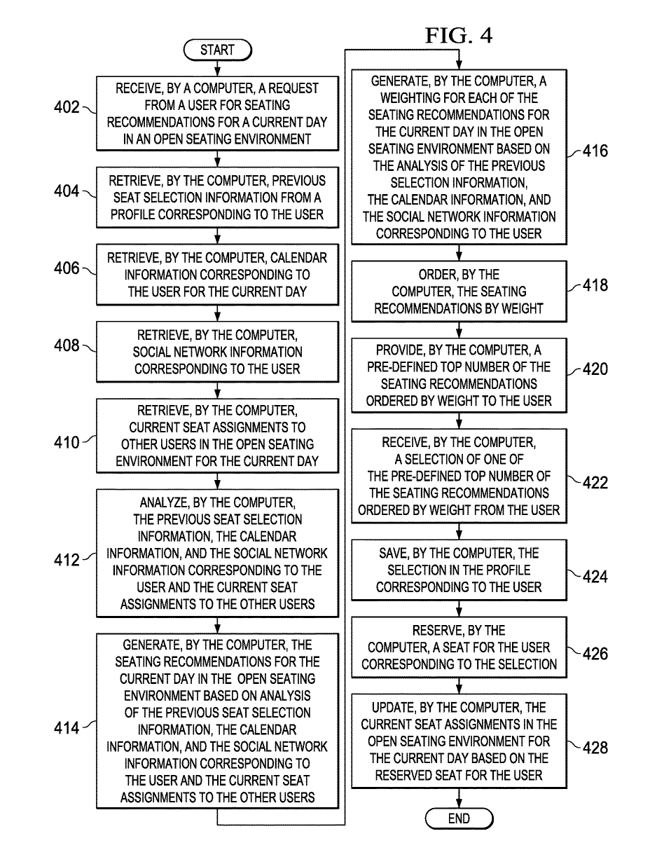

With reference now to FIG. 4, a flowchart illustrating a process for providing seating recommendations is shown in accordance with an illustrative embodiment. The process shown in FIG. 4 may be implemented in a computer, such as, for example, server 106 in FIG. 1 and data processing system 200 in FIG. 2.

The process begins when the computer receives a request from a user for seating recommendations for a current day in an open seating environment (step 402). After receiving the request in step 402, the computer retrieves previous seat selection information from a profile corresponding to the user (step 404). The computer also retrieves calendar information corresponding to the user for the current day (step 406). In addition, the computer retrieves social network information corresponding to the user (step 408). Further, the computer retrieves current seat assignments to other users in the open seating environment for the current day (step 410).

Subsequently, the computer analyzes the previous seat selection information, the calendar information, and the social network information corresponding to the user and the current seat assignments to the other users (step 412). The computer generates the seating recommendations for the current day in the open seating environment based on analysis of the previous seat selection information, the calendar information, and the social network information corresponding to the user and the current seat assignments to the other users (step 414). Furthermore, the computer generates a weighting for each of the seating recommendations for the current day in the open seating environment based on the analysis of the previous selection information, the calendar information, and the social network information corresponding to the user (step 416).

In addition, the computer orders the seating recommendations by weight (step 418). Afterward, the computer provides a pre-defined top number of the seating recommendations ordered by weight to the user (step 420). Subsequently, the computer receives a selection of one of the pre-defined top number of the seating recommendations ordered by weight from the user (step 422).

The computer saves the selection in the profile corresponding to the user (step 424). The computer also reserves a seat for the user corresponding to the selection (step 426). Further, the computer updates the current seat assignments in the open seating environment for the current day based on the reserved seat for the user (step 428). Thereafter, the process terminates.

Thus, illustrative embodiments of the present invention provide a computer-implemented method, computer system, and computer program product for automatically providing intelligent seating recommendations for a current day within an open seating environment to a user based on previous seat selection information, calendar information, and social network information corresponding to the user. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for providing seating recommendations, the computer-implemented method comprising:
generating, by a computer, the seating recommendations for a current day in an open seating environment based on analysis of previous seat selection information, calendar information, and social network information corresponding to a user and current seat assignments to other users in the open seating environment;
generating, by the computer, a weight for each of the seating recommendations for the current day in the open seating environment based on the analysis of the previous selection information, the calendar information, and the social network information corresponding to the user;
ordering, by the computer, the seating recommendations by weight; and
providing, by the computer, a pre-defined top number of the seating recommendations ordered by weight to the user.

2. The computer-implemented method of claim 1 further comprising:
receiving, by the computer, a selection of one of the pre-defined top number of the seating recommendations ordered by weight from the user;
saving, by the computer, the selection in a profile corresponding to the user; and
reserving, by the computer, a seat for the user in the open seating environment corresponding to the selection.

3. The computer-implemented method of claim 2 further comprising:
updating, by the computer, current seat assignments in the open seating environment for the current day based on the seat reserved for the user.

4. The computer-implemented method of claim 1 further comprising:
receiving, by the computer, a request for the seating recommendations for the current day in the open seating environment from a client device corresponding to the user via a network.

5. The computer-implemented method of claim 1 further comprising:
retrieving, by the computer, the previous seat selection information from a profile corresponding to the user;
retrieving, by the computer, the calendar information corresponding to the user for the current day from an electronic calendar stored in a client device corresponding to the user;
retrieving, by the computer, the social network information corresponding to the user from a set of social networks corresponding to the user;
retrieving, by the computer, the current seat assignments to the other users in the open seating environment for the current day from a storage device; and
analyzing, by the computer, the previous seat selection information, the calendar information, and the social network information corresponding to the user and the current seat assignments to the other users.

6. The computer-implemented method of claim 1, wherein the open seating environment is an open seating work environment, and wherein the user is an employee of an enterprise associated with the open seating work environment.

7. The computer-implemented method of claim 1, wherein the weight for each of the seating recommendations for the current day in the open seating environment is a plain text message describing how a particular seating recommendation meets seating preferences of the user.

8. The computer-implemented method of claim 1, wherein the weight for each of the seating recommendations for the current day in the open seating environment is a numerical score that indicates a level of how well a particular seating recommendation meets seating preferences of the user.

9. The computer-implemented method of claim 1, wherein the weight is a combination of two or more weighting factors corresponding to the user.

10. A computer system for providing seating recommendations, the computer system comprising:
a bus system;
a storage device connected to the bus system, wherein the storage device stores program instructions; and
a processor connected to the bus system, wherein the processor executes the program instructions to:
generate the seating recommendations for a current day in an open seating environment based on analysis of previous seat selection information, calendar information, and social network information corresponding to a user and current seat assignments to other users in the open seating environment;
generate a weight for each of the seating recommendations for the current day in the open seating environment based on the analysis of the previous selection information, the calendar information, and the social network information corresponding to the user;
order the seating recommendations by weight; and
provide a pre-defined top number of the seating recommendations ordered by weight to the user.

11. The computer system of claim 10, wherein the processor further executes the program instructions to:
receive a selection of one of the pre-defined top number of the seating recommendations ordered by weight from the user;
save the selection in a profile corresponding to the user; and
reserve a seat for the user in the open seating environment corresponding to the selection.

12. The computer system of claim 11, wherein the processor further executes the program instructions to:
update current seat assignments in the open seating environment for the current day based on the seat reserved for the user.

13. A computer program product for providing seating recommendations, the computer program product comprising a computer readable storage medium having program instructions embodied therewith, the program instructions executable by a computer to cause the computer to perform a method comprising:
generating, by a computer, the seating recommendations for a current day in an open seating environment based on analysis of previous seat selection information, calendar information, and social network information corresponding to a user and current seat assignments to other users in the open seating environment;
generating, by the computer, a weight for each of the seating recommendations for the current day in the open seating environment based on the analysis of the previous selection information, the calendar information, and the social network information corresponding to the user;
ordering, by the computer, the seating recommendations by weight; and
providing, by the computer, a pre-defined top number of the seating recommendations ordered by weight to the user.

14. The computer program product of claim 13 further comprising:
receiving, by the computer, a selection of one of the pre-defined top number of the seating recommendations ordered by weight from the user;
saving, by the computer, the selection in a profile corresponding to the user; and
reserving, by the computer, a seat for the user in the open seating environment corresponding to the selection.

15. The computer program product of claim 14 further comprising:
updating, by the computer, current seat assignments in the open seating environment for the current day based on the seat reserved for the user.

16. The computer program product of claim 13 further comprising:
receiving, by the computer, a request for the seating recommendations for the current day in the open seating environment from a client device corresponding to the user via a network.

17. The computer program product of claim 13 further comprising:
retrieving, by the computer, the previous seat selection information from a profile corresponding to the user;
retrieving, by the computer, the calendar information corresponding to the user for the current day from an electronic calendar stored in a client device corresponding to the user;
retrieving, by the computer, the social network information corresponding to the user from a set of social networks corresponding to the user;
retrieving, by the computer, the current seat assignments to the other users in the open seating environment for the current day from a storage device; and
analyzing, by the computer, the previous seat selection information, the calendar information, and the social network information corresponding to the user and the current seat assignments to the other users.

18. The computer program product of claim 13, wherein the open seating environment is an open seating work environment, and wherein the user is an employee of an enterprise associated with the open seating work environment.

19. The computer program product of claim 13, wherein the weight for each of the seating recommendations for the current day in the open seating environment is a plain text message describing how a particular seating recommendation meets seating preferences of the user.

20. The computer program product of claim 13, wherein the weight for each of the seating recommendations for the current day in the open seating environment is a numerical score that indicates a level of how well a particular seating recommendation meets seating preferences of the user.
